(19) United States
(12) Patent Application Publication
(10) Pub. No.: US 2014/0266498 A1
(43) Pub. Date: Sep. 18, 2014

(54) TRANSFER DEVICE FOR MICROWAVE SIGNALS

(71) Applicant: Apollo Microwaves, Ltd., Dorval (CA)

(72) Inventors: Vasilios (Bill) Tsounis, Beaconsfield (CA); Nick Vouloumanos, Westmount (CA)

(21) Appl. No.: 14/028,195

(22) Filed: Sep. 16, 2013

Related U.S. Application Data
(60) Provisional application No. 61/794,865, filed on Mar. 15, 2013.

(51) Int. Cl. H01P 1/10

(52) U.S. Cl. CPC H01P 1/10
USPC 333/108

(57) ABSTRACT

A transfer device for microwave signals is presented. The transfer device comprises a housing defining a cavity therein, input ports and output ports defined on walls of the housing and a translatably displaceable waveguide structure positioned within the cavity and including at least two selectable functional segments. In use the translatably displaceable waveguide structure is displaced within the cavity to apply a selected function, such as a switching function and/or a combining function, to microwave signals propagating between the input ports and the output ports. Optionally, the transfer device may include multiple stacked translatably displaceable waveguide structures which can be independently displaced within the housing to apply a desired function to the microwave signals propagating between the input ports and the output ports. A method of using such transfer device is also presented.

### CROSS-REFERENCE TO RELATED APPLICATION

For the purpose of the United States, the present application claims the benefit of priority under 35 USC §119e) based on U.S. provisional patent application Ser. No. 61/794,865 filed on Mar. 15, 2013 by Nick Vouloumanos et al. and presently pending. The contents of the above-referenced document are incorporated herein by reference.

### FIELD OF THE INVENTION

This application relates generally to the field of microwave components and, more specifically, to microwave transfer devices used to combine and/or switch microwave signals traveling in different paths to and from microwave antennas, transmitters, receivers and other microwave loads. The invention has numerous applications and has particular utility in satellite communications equipment encompassing both ground and space segments.

### BACKGROUND

In many applications, it is necessary to switch and/or combine microwave signals traveling in different paths to and from microwave antennas, transmitters, receivers and other microwave loads. In this regard, various practical transfer devices have been previously suggested.

A deficiency associated with many conventional transfer devices used to selectively switch and/or combine microwave signals is that they are typically bulky and/or complex to operate.

In light of the above, there is a need to provide improved transfer devices for microwave signals alleviate at least in part the deficiencies of the existing devices.

### SUMMARY

In accordance with a first aspect, the invention relates to a transfer device for microwave signals. The transfer device comprises a housing defining a cavity therein, input ports and output ports defined on walls of the housing, wherein the input ports are located on a first wall of the housing, and the output ports are located on a second wall of the housing. The transfer device also comprises a translatably displaceable waveguide structure positioned within the cavity defined by the housing. The translatably displaceable waveguide structure includes at least two selectable functional segments allowing to apply a selected function to microwave signals propagating between the input ports and the output ports. In use the translatably displaceable waveguide structure is displaced within the cavity to selectively align a specific one of the at least two selectable functional segments with at least some of the input ports and at least some of the output ports.

In a specific implementation, the selected function is selected from the set consisting of: (a) at least one switching function; and (b) at least one combining function.

In specific implementations, the input ports and the output ports are in the form of apertures configured in either the H-plane or the E-plane.

In a specific implementation, the first wall, on which are located the input ports, is positioned generally opposite the second wall, on which are located the output ports. In a practical implementation in which the housing has a generally rectangular shape, the first wall and second walls are opposing walls of the generally rectangular shape.

In a specific implementation, the two selectable functional segments of the translatably displaceable waveguide structure define respective sets of microwave transmission passages.

In a specific implementation, the transfer device further comprises an actuator for displacing the translatably displaceable waveguide structure within the cavity defined by the housing to selectively align a specific selectable functional segment of the translatably displaceable waveguide structure with at least some of the input and output ports of the device. In practical implementations, the actuator may include a manually operable mechanism, an electrically powered driving mechanism or both a manually operable mechanism and an electrically powered driving mechanism for displacing the translatably displaceable waveguide structure within the cavity.

In a specific implementation, the two selectable functional segments include a first selectable functional segment and a second selectable functional segment. In use, when the first selectable functional segment is aligned with the input ports and the output ports of the transfer device, the selected function is a first specific switching function causing microwave signals applied to the input ports to be switched toward the output ports in a first manner. Conversely, when the second selectable functional segment is aligned with the input ports and the output ports of the transfer device, the selected function is a second specific switching function causing microwave signals applied to the input ports to be switched toward the output ports in a second manner distinct from the first manner. Optionally, the translatably displaceable waveguide structure may includes a third selectable functional segment. In use, when the third selectable functional segment is aligned with the input ports and the output ports, the selected function is a first specific combining function causing microwave signals applied to the input ports to be combined prior to being released at the output ports so that signals released at the output ports are combined versions of the microwave signals applied to the input ports.

In a practical example in which the input ports include a first input port and a second input port and the output ports include a first output port and a second output port, when the first selectable functional segment is aligned with the input ports and the output ports, the selected function is a first specific switching function causing microwave signals applied to the first input port to be switched toward the first output port and causing microwave signals applied to the second input port to be switched toward the second output port. Conversely, when the second selectable functional segment is aligned with the input ports and the output ports, the selected function is a second specific switching function causing microwave signals applied to the first input port to be switched toward the second output port and causing microwave signals applied to the second input port to be switched toward the first output port.

In the practical example in which the input ports include a first input port and a second input port and the output ports include a first output port and a second output port, the first input port and the second output port may lie on a same first plane and the second input port and the first output port may lie on a same second plane, wherein the first plane and the second plane are distinct from one another.

In a specific implementation, the two selectable functional segments of the translatably displaceable waveguide structure define respective sets of microwave transmission passages, wherein microwave transmission passages in at least one of the respective sets of microwave transmission passages are positioned side-by-side on the translatably displaceable waveguide structure along an axis longitudinal to a direction of displacement of the translatably displaceable waveguide structure.

In accordance with another aspect, the invention relates to a transfer device for selectively combining and switching microwave signals. The transfer device comprises: a housing; input ports and output ports defined on walls of the housing; a first translatably displaceable waveguide structure positioned within the housing and a second translatably displaceable waveguide structure positioned within the housing. The first translatably displaceable waveguide structure includes at least two selectable functional segments and is selectively translatable along a first axis. The second translatably displaceable waveguide structure also includes at least two selectable functional segments and is selectively translatable along a second axis. In use the first and second translatably displaceable waveguide structures are displaced within the housing for selectively combining and switching microwave signals between the input ports and the output ports defined on the walls of the housing. The first translatably displaceable waveguide structure and the second translatably displaceable waveguide structure are configured so that microwave signals received at the input ports of the transfer device propagate through the first translatably displaceable waveguide structure and through the second translatably displaceable waveguide structure prior to being released at the output ports.

In specific examples of implementation, the first and second translatably displaceable waveguide structures can be displaced independently from one another within the housing.

In a first specific example of implementation, the housing defines a cavity therein and the first translatably displaceable waveguide structure and the second translatably displaceable waveguide structure are positioned within the defined cavity.

In an alternate example of implementation, the housing defines at least two cavities therein including a first cavity and a second cavity. The first translatably displaceable waveguide structure is positioned within the first cavity and the second translatably displaceable waveguide structure is positioned within the second cavity. In a specific implementation, the first cavity and second cavity are separated one from there other by a dividing wall, wherein the dividing wall includes apertures permitting communication between the first cavity and the second cavity.

In specific examples of implementation, the input ports are located on a first wall of the housing and the output ports are located on a second wall of the housing, the first wall being positioned opposite the second wall. In a practical implementation in which the housing has a generally rectangular shape, the first wall and second walls are opposing walls of the generally rectangular shape.

In a specific example, the transfer device further comprises an actuator for displacing the first translatably displaceable waveguide structure within the housing to selectively align a specific one of the at least two selectable functional segments of the first translatably displaceable waveguide structure with the input ports. The same actuator may be further configured, or a separate actuator may be provided, for displacing the second translatably displaceable waveguide structure within the housing to selectively align a specific one of the at least two selectable functional segments of the second translatably displaceable waveguide structure with the output ports.

In a practical example in which the input ports include a first input port and a second input port and the output ports include a first output port and a second output port, the first input port and the second output port may lie on a same first plane and the second input port and the first output port may lie on a same second plane. The first plane and the second plane may be distinct from one another or alternatively, may be co-planar with one another.

In accordance with another aspect, the invention relates to a method for use in connection with microwave signals. The method comprises providing a transfer device comprising a housing defining a cavity therein, input ports and output ports defined on walls of the housing wherein the input ports are located on a first wall of the housing, and the output ports are located on a second wall of the housing, and a translatably displaceable waveguide structure positioned within the cavity defined by the housing, wherein the translatably displaceable waveguide structure includes at least two selectable functional segments allowing to apply a selected function to microwave signals propagating between the input ports and the output ports. The method further comprises displacing the translatably displaceable waveguide structure of the transfer device within the cavity to align one of the at least two selectable functional segments with the input ports and the output ports. The method further comprises causing microwave signals to be propagated through a circuit including the transfer device so that microwave signals received at the input ports of the transfer device propagate toward the output ports through the aligned one of the at least two selectable functional segments.

In accordance with another aspect, the invention relates to a transfer device for selectively combining and switching microwave signals. The transfer device comprises a housing defining a cavity therein, input ports and output ports defined on walls of said housing, and a translatably displaceable waveguide structure positioned within the cavity defined by the housing. The translatably displaceable waveguide structure includes at least two selectable functional segments. In use, the translatably displaceable waveguide structure is displaced within the cavity for selectively combining and switching microwave signals between the input ports and the output ports defined on the walls of the housing.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

A detailed description of specific embodiments of the present invention is provided herein below with reference to the accompanying drawings in which:

FIGS. 1A and 1B show conceptual diagrams of a transfer device in accordance with a first specific example of implementation of the present invention.

FIG. 2 shows a conceptual diagram of a displaceable waveguide structure suitable for use in the transfer device depicted in FIGS. 1A and 1B.

FIGS. 3A to 3C the transfer device of FIGS. 1A and 1B the displaceable waveguide structure of FIG. 2 in different positions.

FIGS. 4A and 4B show conceptual diagrams of a transfer device in accordance with a second specific non-limiting example of implementation of the present invention.

FIG. 5 shows a conceptual diagram of a displaceable waveguide structure suitable for use in the transfer device depicted in FIGS. 4A and 4B.

FIGS. 6A to 6C the transfer device of FIGS. 4A and 4B with the displaceable waveguide structure of FIG. 5 in different positions.

FIGS. 7A and 7B show conceptual diagrams of a transfer device in accordance with a third specific non-limiting example of implementation of the present invention including two stacked displaceable waveguide structure.

FIG. 8 shows conceptual diagrams of the two displaceable waveguide structures suitable for use in the transfer device depicted in FIGS. 7A and 7B.

FIGS. 9A to 9C the transfer device of FIGS. 7A and 7B with the two displaceable waveguide structures of FIG. 8 in different positions.

FIG. 10 shows a mathematical representation of signals travelling through the two the combiner portions of each of the displaceable waveguide structures (in the configuration shows in FIG. 9C).

FIGS. 11A to 11D show conceptual diagrams of a transfer device in accordance with a fourth specific non-limiting example of implementation of the present invention.

In the drawings, embodiments of the invention are illustrated by way of example. It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

Generally, the present invention relates to a transfer device that uses one or more translatably displaceable waveguide structures in order to apply a selected function to microwave signals applied to input ports of the transfer device as they propagate towards the output ports of the device. The transfer device proposed can be used, for example, to combine and/or switch microwave signals as they propagate between input and output ports of the device. In particular the displaceable waveguide structure used for selected the function to apply to microwave signal can be controlled without rotation or angular displacement of the displaceable waveguide structure.

Such a transfer device has particular utility in applications in satellite communications equipment encompassing both ground and space segments.

One non-limiting embodiment of the proposed transfer device is depicted in FIGS. 1A and 1B. As shown, the transfer device 100 is comprised of a generally rectangular housing 102 in which is defined a generally rectangular cavity 104. The housing 102 has two apertures 150 152 forming input ports (port A and port B) defined on one wall 108 (shown in FIG. 1A) and two apertures 160 162 forming output ports (port C and port D) defined on another wall 210 (shown in FIG. 1B). In the embodiment depicted, wall 108 and wall 210 are opposing walls of the housing 102. In alternative embodiments (not shown in the figures), the input ports and output ports may be positioned on respective walls adjacent to one another, rather than on opposing walls. In the example depicted, the two apertures 150 152 forming the input ports (port A and port B) are positioned side-by-side on the wall 108 of the housing 102 in an offset relationship with one another, meaning that they are positioned at different levels on the wall 108. Similarly, the two apertures 160 162 forming the output ports (port C and port D) are positioned side-by-side on the wall 210 of the housing 102 in an offset relationship with one another.

The housing 102 also includes a lower surface (not shown) enclosing the bottom surface of the cavity 104. In addition, while not shown in the figures, the transfer devices depicted in FIGS. 1A and 1B may further comprise a cover member for enclosing the top of the cavity 104 defined by the housing. The cover member may be made from materials that minimize pressure variability within the device 100 such as, for example, rubber or rubber-like materials. Alternatively, the cover member may be made of the same material as the housing.

The transfer device 100 also includes a displaceable waveguide structure 200 that is positioned within the cavity 104 defined in the housing 102. In the example shown and as better illustrated in FIG. 2, the displaceable waveguide structure 200 includes three distinct functional segments 202 204 206 each defining respective sets of microwave transmission passages that can be aligned with the apertures 150 152 160 162 forming the input and output ports of the device 100. In the example depicted, the displaceable waveguide structure 200 can be translatably displaced by sliding it within the cavity 104 so as to selectively align one of the three distinct functional segments 202 204 206 with the apertures 150 152 160 162 forming the input and output ports of the device 100. The cavity 104 is shaped and has dimensions to accommodate the sliding therein of the displaceable waveguide structure 200.

In specific implementations, suitable guiding structures, such as for example guiding channels or grooves (not shown in the Figures), may be provided in the cavity 104 and/or on the displaceable waveguide structure 200 for assisting in the sliding of the displaceable waveguide structure 200 within the cavity 104. Such guiding structures may be positioned in any suitable locations within the device 100. In a first example, guiding structures are located around at least a portion of the inner periphery of the cavity 104 and complementary guiding structures are located along the sides of the displaceable waveguide structure 200 that engage the inner periphery of the cavity so as to assist in the sliding of the displaceable waveguide structure 200 within the cavity 104. In a second example, guiding structures are provided on the bottom surface (not shown) of the cavity 104 and complementary guiding structures are located on the surface of the displaceable waveguide structure 200 that engages the bottom surface (not shown) of the cavity 104.

A suitable alignment mechanism may also provided for assisting in establishing suitable path continuity between the apertures 150 152 forming input ports, the transmission passages defined in the functional segments 202 204 206 of the waveguide structure 200 and the apertures 160 162 forming output ports. Examples of alignment mechanisms include, without being limited to, mechanical stoppers for controlling the extent of displacement of the waveguide structure 200 and micro-switches for cutting power to and electrically powered driving mechanism used to displace the waveguide structure 200 based on the position of waveguide structure 200 within cavity 104. The person skilled in the art will appreciated that any suitable alignment mechanism for establishing path continuity may be used in alternative implementations.

In the example depicted, when the first functional segment 202 is aligned with the apertures 150 152 160 162 forming the input and output ports of the housing 102 (as shown in FIG. 3A), a first transmission passage is established between port A and port C and a second transmission passage is established between port B and port D so that the following first switching relationship is established:
port A (a↑)→port C(a↑)
port B(b↑)→port D(b↑)

As such, when the first functional segment 202 is aligned with the apertures 150 152 160 162 forming the input and output ports, a switching function is selected causing microwave signals, denoted as a↑ and b↑ above, applied to input ports A and B of the transfer device 100 to be switched in the manner specified by the above first switching relationship as they propagate toward the output ports C and D.

In the example depicted, when the second functional segment 204 is aligned with the apertures 150 152 160 162 forming the input and output ports of the housing 102 (as shown in FIG. 3B), transmission passages for combining microwave signals are established between input ports A and B and output ports C and D so that the following combining relationship is established:

port A (a↑)→port C (a₁↑) (b₁←)
port B (b↑)→port D (a₂←)(b₂↑)
where the arrow orientation counterclockwise movement above represents the principle of phase lagging created by the combiner and where substantially:
microwave signal a↑=a₁↑+a₂↑ and
microwave signal b↑=b₁↑+b₂↑.

As such, when the second functional segment 204 is aligned with the apertures 150 152 160 162 forming the input and output ports, a combining function is selected causing microwave signals applied to input ports A and B of the transfer device 100 to be combined in the manner specified by the above combining relationship as they propagate toward the output ports C and D. As a result, signals released at output ports C and D correspond to combined versions of microwave signals applied to the input ports A and B.

In the example depicted, when the third functional segment 206 is aligned with the apertures 150 152 160 162 forming the input and output ports of the housing 102 (as shown in FIG. 3C), a first transmission passage is established between port A and port D and a second transmission passage is established between port B and port C so that the following second switching relationship is established:
port A (a↑)→port D (a↑)
port B (b↑)→port C (b↑)

As such, when the third functional segment 206 is aligned with the apertures 150 152 160 162 forming the input and output ports, a switching function is selected causing microwave signals applied to input ports A and B of the transfer device 100 to be switched in the manner specified by the above switching relationship toward the output ports C and D.

The offset configurations between the apertures 150 152 forming input ports on wall 108 and between the apertures 160 162 forming output ports on wall 210 allows the transmission passages in the third functional segment 206 to cross over one another, as shown in FIG. 2 and FIG. 3C, without having the transmission passages intersect one another. It is to be appreciated that other configurations may also allow transmission passages to cross over one another without having the transmission passages intersect one another. For example, if the two apertures 150 152 forming the input ports (port A and port B) are positioned side-by-side on the wall 108 of the housing 102 in an offset relationship with one another, the two apertures 160 162 forming the output ports (port C and port D) may be positioned at the same level or in an offset relationship with one another on the wall 210 while still providing the advantage of allowing transmission passages to cross over one another without having the transmission passages intersect one another.

The displaceable waveguide structure 200 can be displaced by any suitable actuator (no shown in the Figures), which may include a manually operable mechanism and/or any suitable electrically powered driving mechanism, in order to position the waveguide structure 200 in one of the depicted three (3) possible positions. In a specific example of implementation, to provide redundancy, multiple actuators can be provided. In a non-limiting implementation, both a manually operable mechanism and a suitable electrically powered driving mechanism are provided to allow the displaceable waveguide structure to be controlled by either one or both mechanisms. Any suitable mechanism may be used to drive the actuator. For example, a linear solenoid could be suitable for moving a relatively small waveguide structure. Other sizes may make use of pneumatic cylinder with the movable member attached to the piston of the cylinder, and the like. In a specific non-limiting implementation, a linear-gear controlled using a motor (such as for example a stepper motor) is used control the displacement of the waveguide structure 200 within the cavity 104. Such a mechanism alone or combined with suitable alignment mechanisms of the type described earlier in the present document, provide an increased precision in the control of the displacement of the waveguide structure 200 within the cavity 104 and assist in establishing suitable path continuity between the apertures 150 152 forming input ports, the transmission passages defined in the functional segments 202 204 206 and the apertures 160 162 forming output ports.

Another non-limiting embodiment of the proposed transfer device is depicted in FIGS. 4A and 4B. The embodiment shown in FIGS. 4A and 4B is similar in structure and operation to the embodiment described above with reference to FIGS. 1A and 1B. A distinction between the two embodiments is that while in the embodiment of FIGS. 1A and 1B the device 100 is oriented in a generally horizontal plane, in the embodiment of FIGS. 4A and 4B the device 300 is oriented in a generally upright or vertical plane. As shown, the transfer device 300 according to the embodiment depicted in FIGS. 4A and 4B is comprised of a generally rectangular housing 302, analogous to housing 102 shown in FIGS. 1A and 1B, in which is defined a cavity 304, analogous to cavity 104 shown in FIGS. 1A and 1B. The housing 302 has two apertures 350 352 forming input ports (port A and port B) defined on one wall 308 (shown in FIG. 4A) and two apertures 360 362 forming output ports (port C and port D) defined on an opposing wall 310 (shown in FIG. 4B). The apertures 350 352 360 362 are analogous to apertures 150 152 160 162 shown in FIGS. 1A and 1B and may be positioned on the walls of the device 300 in a manner similar to that described above with respect to apertures 150 152 160 162. The transfer device 300 also includes a displaceable waveguide structure 400, analogous to displaceable waveguide structure 200 shown in FIGS. 1A and 1B, that is positioned within the cavity 304 defined in the housing 302. In the example shown and as better illustrated in FIG. 5, the displaceable waveguide structure 400 includes three distinct functional segments 402 404 406, analogous to functional segments 202 204 206 shown in FIG. 2, each defining respective sets of microwave transmission passages between two input ports and two output ports. The displaceable waveguide structure 400 can be translatably displaced within the cavity 304 by sliding in the cavity 304 in a manner similar to displaceable waveguide structure 200 described above, so as to selectively align one of the three distinct functional segments 402 404 406 with the input and output ports of the housing 302. The movement of the displaceable waveguide structure 400 generally involves sliding the structure in an upward or downward direction rather than sliding the structure in a generally horizontal direction as was the case in the embodiment of FIGS. 1A and 1B.

While not shown in the figures, the housing 202 also includes a side surface, corresponding to the right side surface of the device 300 as shown in the drawings, enclosing the side of the cavity 304. In addition, also not shown in the figures, the transfer devices depicted in FIGS. 4A and 4B may further comprise a cover member for enclosing the side of the cavity 304, corresponding to the left side surface of the device 300 as shown in the drawings. The cover member may be made from materials that minimize pressure variability within the device 300 such as, for example, rubber or rubber-like materials. Alternatively, the cover member may be made of the same material as the housing.

As was described with reference to the embodiment of FIGS. 1A and 1B, suitable guiding structures, such as for example guiding channels or grooves (not shown in the Figures), may be provided in the cavity 304 and/or on the displaceable waveguide structure 400 for assisting in the sliding of the displaceable waveguide structure 400 within the cavity 304. In addition, aligning mechanisms (such as mechanical stoppers, micro-switches and the like) for assisting in establishing suitable path continuity between the input ports, the transmission passages and the output ports of the device 300 may also be provided.

FIGS. 6A, 6B and 6C show the displaceable waveguide structure 400 in different positions to align the different functional segments 402 404 406 with the apertures 350 352 360 362 forming the input and output ports of the housing 302. Depending on which of the functional segments 402 404 406, a corresponding function is applied to microwave signals propagating between the input ports and the output ports of the device 302. In a manner similar to that described for the displaceable waveguide structure 100 with reference to the embodiment of FIGS. 1A and 1B, the displaceable waveguide structure 400 can be displaced by an actuator, which may include a manually operable mechanism and/or any suitable electrically powered driving mechanism, in order to position the displaceable waveguide structure 400 in one of the three (3) possible positions depicted in FIGS. 6A, 6B and 6C.

Yet another non-limiting embodiment of the proposed transfer device is depicted in FIGS. 7A and 7B. As shown, the transfer device 500 is comprised of a generally rectangular housing 502. The housing 502 has two apertures 550 552 forming input ports (port A and port B) defined on one wall 508 (shown in FIG. 7A) and two apertures forming output ports (port C and port D) defined on another wall 510 (shown in FIG. 7B). In the embodiment depicted, wall 508 and wall 510 are opposing walls of the housing 502. In the example depicted, the two apertures 550 552 forming the input ports (port A and port B) are positioned side-by-side and are aligned on the wall 508 of the housing 502, meaning that they are positioned essentially at the same level on the wall 108. Similarly, in the example depicted, the two apertures 560 562 forming the output ports (port C and port D) are positioned side-by-side and are aligned on the wall 210 of the housing 102. Conversely, in the embodiments depicted in FIGS. 1A and 1B, two apertures 150 152 forming the input ports (port A and port B) were positioned side-by-side on walls 108 of the housing 102 in an offset relationship with one another and the two apertures 160 162 forming the output ports (port C and port D) were also positioned side-by-side on walls 210 of the housing 102 in an offset relationship with one another.

The transfer device 500 also includes a first displaceable waveguide structure 600 and a second displaceable waveguide structure 600′. In the embodiment depicted in FIGS. 7A and 7B, the housing 502 defines a cavity 504 in which the first displaceable waveguide structure 600 and the second displaceable waveguide structure 600′ are positioned.

As better illustrated in FIG. 8, the displaceable waveguide structure 600 includes two distinct functional segments 612 and 604. For the purposes of this example, the displaceable waveguide structure 600′ is essentially identical to the displaceable waveguide structure 600 and as such also includes two distinct functional segments 612′ and 604′. However, the person skilled in the art will understand that the displaceable waveguide structure 600′ can be differently configured relative to the displaceable waveguide structure 600, for example the displaceable waveguide structure 600′ can be configured such that the functional segments are spatially inverted relative to the functional segments in the displaceable waveguide structure 600.

Functional segments 612 604 612′ 614′ each define respective sets of microwave transmission passages between two input ports and two output ports. The displaceable waveguide structures 600 600′ can be displaced within the cavity 504 to selectively align one of the two distinct functional segments 612 and 604 with the apertures 550 552 forming the input ports (Port A and Port B) and to selectively align one of the two distinct functional segments 612′ and 604′ with the apertures 560 562 forming the output ports (Port C and Port D). In this example, the displaceable transfer structures 600 and 600′ can be independently translatably displaced by sliding them within the cavity 504 along respective axes. The cavity 504 is shaped and has dimensions to accommodate this sliding therein of the displaceable waveguide structures 600 and 600′.

In specific implementations, suitable guiding structures, such as for example guiding channels or grooves (not shown in the Figures), may be provided in the cavity 504 and/or on the displaceable waveguide structures 600 600′ for assisting in the sliding of the displaceable waveguide structures 600 600′ within the cavity 504. Such guiding structures may be positioned in any suitable locations within the device 500. In a first example, guiding structures are provided around at least a portion of the inner periphery of the cavity 504 and complementary guiding structures are provided along the sides of the displaceable waveguide structures 600 600′ that engage the inner periphery of the cavity 504. In a second example, guiding structures are provided on the bottom surface (not shown) of the cavity 504 and complementary guiding structures are provided on the surface of the displaceable waveguide structures 600 600′ that engages the bottom surface (not shown) of the cavity 504. In addition, aligning mechanisms (such as mechanical stoppers, micro-switches and the like) for assisting in establishing suitable path continuity between the input ports, the transmission passages and the output ports of the device 500 may also be provided.

In use, the first and second displaceable waveguide structures 600 600′ cooperate with one another in order to selectively combine and switch microwave signals propagating between the apertures 550 552 560 562 forming the input ports and the output ports of the device 500. As depicted in FIGS. 7A and 7B, the first and second translatably displaceable waveguide structures 600 600′ are configured so that microwave signals received at the apertures 550 552 forming the input ports (Port A and Port B) of the transfer device propagate through the first translatably displaceable waveguide structure 600 and through the second translatably displaceable waveguide structure 600′ prior to being released at the apertures 560 562 forming the output ports (Port C and Port D) of the device 500.

In the example depicted, when the first functional segment 612 of structure 600 is aligned with the apertures 550 552 forming the input ports of the housing 502, and the first functional segment 612′ of structure 600′ is aligned with the first functional segment 612 of structure 600 and with the apertures 560 562 forming the output ports of the housing 502 (as shown in FIG. 9A), a first transmission passage is established between port A and port C and a second transmission passage is established between port B and port D so that the following switching relationship is established:
port A (a↑)→port C (a↑)
port B(b↑)→port D (b↑)

As such, when the first and second translatably displaceable waveguide structures 600 600′ and positioned within the housing in the manner shown in FIG. 9A, a switching function is selected causing microwave signals applied to input ports A and B of the transfer device 500 to be switched in the manner specified by the above first switching relationship as they propagate toward the output ports C and D.

In the example depicted, when the first functional segment 612 of structure 600 is aligned with the apertures 550 552 forming the input ports of the housing 502, and the second functional segment 604′ of structure 600′ is aligned with the output of the first functional segment 612 and with the apertures 560 562 forming the output ports of the housing 502 (as shown in FIG. 9B), transmission passages for combining microwave signals are established between input ports A and B and output ports C and D so that the following combining relationship is established:

port A (a↑)→port C (a₁↑) (b₁←)
port B (b↑)→port D (a₂←)(b₂↑)
where the above counterclockwise movement of the arrow orientation represents the principle of phase lagging created by the combiner, and where substantially:
microwave signal a↑=a₁↑+a₂↑ and
microwave signal b↑=b₁↑+b₂↑

As such, when the first and second translatably displaceable waveguide structures 600 600′ and positioned within the housing in the manner shown in FIG. 9B, a combining function is selected causing microwave signals applied to input ports A and B of the transfer device 500 to be combined in the manner specified by the above combining relationship as they propagate toward the output ports C and D. As a result, signals released at output ports C and D correspond to combine versions of microwave signals applied to the input ports A and B.

In the example depicted, when the second functional segment 604 of structure 600 is aligned with the apertures 550 552 forming the input ports of the housing 502, and the second functional segment 604′ of structure 600′ is aligned with the output of the second functional segment 604 and with the apertures 560 562 forming the output ports of the housing 502 (as shown in FIG. 9C), transmission passages for combining microwave signals are established between input ports A and B and output ports C and D so that the following second switching relationship is established:
port A (a↑)→port D (a↑)
port B (b↑)→port C (b↑)

The above switching relationship is implemented by the consecutive combining actions performed by the functional segments 604 and 604′ (combiners), in the manner illustrated in FIG. 10 of the drawings. As shown the combiners implemented by functional segments 604 and 604′ perform the following functions:

port A (a↑)→COMBINER→(a₁↑)(b₁←)→COMBINER→(a₁↑)(a₂↓) (b₁←)(b₂←)→port C (b↑)
port B (b↑)→COMBINER→(a₂←)(b₂↑)→COMBINER→(a₂←)(a₁←) (b₂↑)(b₁↓)→port D (a↑)
where the terms (a₁↑) (b₁←) and (a₂←) (b₂↑) show the intermediate microwave signals obtained at the outputs of functional segment (combiner) 604, where the terms (a₁↑) (a₂↓) (b₁←)(b₂←) and (a₂←)(a₁←) (b₂↑)(b₁↓) show the microwave signals obtained at the outputs of functional segment (combiner) 604′, and where the above counterclockwise movement of the arrow orientation represents the principle of phase lagging created by the combiners.

As such, when the first and second translatably displaceable waveguide structures 600 600′ are positioned within the housing in the manner shown in FIG. 9C, a switching function is selected causing microwave signals applied to input ports A and B of the transfer device 500 to be switched in the manner specified by the above second switching relationship as they propagate toward the output ports C and D.

An advantage of the embodiment depicted in FIGS. 7A and 7B, which use two (2) stacked displaceable waveguide structures 600 and 600′, is that it allows achieving switching and combining functions of the type described with reference to the embodiments described with reference to FIGS. 1A, 1B, 2, 3A-3C, 4A, 4B, 5 and 6A-6C without having transmission passages cross one over the other in the transfer device. Since transmission passages do not need to cross one over the other in the transfer device, apertures 550 552 560 562 defined input ports A and B and output ports C and D may be substantially co-planar (rather than offset from one another as in the examples described with reference to FIGS. 1A-1B and 4A-4B). Being able to position the ports on substantially the same plane can be particularly advantageous in some implementation as it allows a reduced height or thickness of the transfer device 500.

The displaceable waveguide structures 600 and 600′ can be displaced by one or more actuators (no shown in the Figures), which may include manually operable mechanisms and/or any suitable electrically powered driving mechanisms, so as to position the displaceable waveguide structures 600 600′ in one of the positions depicted in FIGS. 9A to 9C. In a specific example of implementation, to provide redundancy, multiple actuators can be provided. In addition, respective actuator or actuators may be provided for each one of the displaceable waveguide structures 600 600′. In a non-limiting implementation, both a manually operable mechanism and a suitable electrically powered driving mechanism are provided so as to allow the displaceable waveguide structure to be controlled by either or both mechanisms. Any suitable mechanism may be used to drive the one or more actuators.

The housing 502 also includes a lower surface (not shown) enclosing the bottom surface of a cavity 504 formed therein. In addition, while not shown in the figures, the transfer devices depicted in FIGS. 7A and 7B may further comprise a cover member for enclosing the top of the cavity 504 defined by the housing. The cover member may be made from materials that minimize pressure variability within the device 500 such as, for example, rubber or rubber-like materials. Alternatively, the cover member may be made of the same material as the housing.

While the embodiment described with reference to FIGS. 7A, 7B, 8 and 9A to 9C shows a device oriented in a generally horizontal plane, alternative embodiments may be oriented in a generally vertical plane in a manner similar to that described with reference to FIGS. 4A, 4B, 5 and 6A to 6C. The configuration of such alternative embodiment oriented in a generally vertical plane or in other planes will become readily apparent to the person skilled in the art in light of the present description and thus, for the purpose of conciseness, will not be described in further detail here.

FIGS. 11A, 11B, 11C and 11D show another alternative embodiment of a transfer device 700. This alternative embodiment is similar to the embodiment described with reference to FIGS. 7A, 7B, 8 and 9A to 9C and includes a housing 702, analogous to housing 502, and two translatably displaceable waveguide structures 800 and 800′, which are analogous to the translatably displaceable waveguide structures 600 and 600′ of FIGS. 9A, 9B and 9C. The housing 702 has two apertures 750 752 forming input ports (port A and port B) defined on one wall 708 (shown in FIG. 7A) and two apertures 760 762 forming output ports (port C and port D) defined on wall 810 (shown in FIG. 7B). The housing 702 also includes a lower surface (not shown) enclosing the bottom surface of the housing 702. The housing 702 further includes a dividing wall 780 that extends along an axis longitudinal to the direction of displacement of the translatably displaceable waveguide structures 800 and 800′. The dividing wall 780, together with the housing 702, defines two cavities 704a 704b within the housing 702. The housing 702 thus includes a first cavity 704a and a second cavity 704b, where the first displaceable waveguide structure 800 is positioned within the first cavity 704a and where the second displaceable waveguide structure 800′ is positioned within the second cavity 704b. The dividing wall 780 also includes apertures 772 775 that are generally located along axes 790 792 extending between apertures 750 752 forming the input ports of the housing 702 and apertures 770 762 forming the output ports of the housing 702.

While the embodiment described with reference to FIGS. 11A to 11D shows a device oriented in a generally horizontal plane, alternative embodiments may be oriented in a generally vertical plane in a manner similar to that described with reference to FIGS. 4A, 4B, 5 and 6A to 6C. The configuration of such alternative embodiment oriented in a generally vertical plane or in other planes will become readily apparent to the person skilled in the art in light of the present description and thus, for the purpose of conciseness, will not be described in further detail here.

While not shown in the figures, the transfer devices depicted in FIGS. 7A-7B and 11A-11D may further comprise respective cover members for enclosing the top of the cavities 504 704a-b formed by the housings. The cover members may be made from materials that minimize pressure variability within the device. Such materials may include, but without being limited thereto, rubber or rubber-like materials. Alternatively, the cover member may be made of the same material as the housing.

While the embodiments depicted in FIGS. 1A-1B; 4A-4B; 7A-7B and 11A-11D show transfer devices with two apertures forming input ports and two apertures forming output ports, it will be appreciated that alternative implementations of the concepts presented above may include more that two input ports and more than two output ports. It is also noted that while in the embodiments depicted the number of input ports is the same as the number of output ports, alternative embodiments need not be so limited and may have unequal numbers of input and output ports. In addition, it is to be appreciated that the apertures forming the input and output ports may be configured in the H or in the E plane depending on the specific application that is desired.

In addition, it is to be appreciated that while the embodiment depicted in FIGS. 1A-1B; 4A-4B; 7A-7B and 11A-11D show transfer devices of a generally rectangular shape, in alternative embodiments the housing may be configured to have any suitable shape such as, for example, a cylinder, a hexagonal prism or the like. Similarly, while the embodiments shown includes rectangular cavities and correspondingly shaped translatably displaceable waveguide structures, it is possible to provide transfer devices having cylindrical cavities and corresponding cylindrical waveguide structures or use a cavities having any other convenient shape such as triangular, hexagonal or the like.

In addition, it is to be appreciated that while the displaceable waveguide structures 200 400 600 600′ 800 and 800′ have been shown as including certain numbers of distinct functional segments, each defining respective sets of microwave transmission passages between input ports and output ports of the transfer device, alternative embodiments of the invention may include fewer than or more than the herein illustrated functional segments depending on the combining and switching function that are to be achieved by the transfer device.

Parts of the herein described devices, including the housing and the displaceable waveguide structure, are machinable by precision metal working machines of the type known in the art of wave guides.

The foregoing is considered as illustrative only of the principles of the invention. Further, since numerous modifications and changes will readily occur to those skilled in the art, it is not desired to limit the invention to the exact examples and embodiments shown and described, and accordingly, suitable modifications and equivalents may be resorted to. It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control.

Although the present invention has been described in considerable detail with reference to certain embodiments thereof, variations and refinements are possible and will become apparent to persons skilled in the art in light of the present description. The invention is defined more particularly by the attached claims.

1. A transfer device for microwave signals comprising:
a. a housing defining a cavity therein;
b. input ports and output ports defined on walls of said housing, wherein the input ports are located on a first wall of the housing, and the output ports are located on a second wall of the housing; and
c. a translatably displaceable waveguide structure positioned within the cavity defined by said housing, said translatably displaceable waveguide structure including at least two selectable functional segments allowing to apply a selected function to microwave signals propagating between the input ports and the output ports, in use said translatably displaceable waveguide structure being displaced within said cavity to selectively align a specific one of said at least two selectable functional segments with at least some of said input ports and at least some of said output ports.

2. A transfer device as defined in claim 1, wherein the selected function is selected from the set consisting of:
a. at least one switching function; and
b. at least one combining function.

3. The transfer device as claimed in claim 2, wherein said first wall is positioned opposite said second wall.

4. The transfer device as claimed in claim 3, wherein said housing has a generally rectangular shape and wherein the first wall and second walls are opposing walls of the generally rectangular shape.

5. The transfer device as claimed in claim 3, wherein said at least two selectable functional segments define respective sets of microwave transmission passages.

6. The transfer device as claimed in claim 5, further comprising an actuator for displacing said translatably displaceable waveguide structure within said cavity to selectively align a specific one of said at least two selectable functional segments with at least some of said input ports and at least some of said output ports.

7. The transfer device as claimed in claim 6, wherein said actuator includes a manually operable mechanism for displacing said translatably displaceable waveguide structure within said cavity.

8. The transfer device as claimed in claim 6, wherein said actuator includes an electrically powered driving mechanism for displacing said translatably displaceable waveguide structure within said cavity.

9. The transfer device as claimed in claim 6, wherein said actuator includes a manually operable mechanism and an electrically powered driving mechanism.

10. The transfer device as claimed in claim 3, wherein said at least two selectable functional segments include a first selectable functional segment and a second selectable functional segment, and wherein in use:
a. when the first selectable functional segment is aligned with the input ports and the output ports, the selected function is a first specific switching function causing microwave signals applied to the input ports to be switched toward the output ports in a first manner; and
b. when the second selectable functional segment is aligned with the input ports and the output ports, the selected function is a second specific switching function causing microwave signals applied to the input ports to be switched toward the output ports in a second manner distinct from the first manner.

11. The transfer device as claimed in claim 3, wherein the input ports include a first input port and a second input port and the output ports include a first output port and a second output port.

12. The transfer device as claimed in claim 11, wherein said at least two selectable functional segments include a first selectable functional segment and a second selectable functional segment, and wherein in use:
a. when the first selectable functional segment is aligned with the input ports and the output ports, the selected function is a first specific switching function causing microwave signals applied to the first input port to be switched toward the first output port and causing microwave signals applied to the second input port to be switched toward the second output port; and
b. when the second selectable functional segment is aligned with the input ports and the output ports, the selected function is a second specific switching function causing microwave signals applied to the first input port to be switched toward the second output port and causing microwave signals applied to the second input port to be switched toward the first output port.

13. The transfer device as claimed in claim 3, wherein said at least two selectable functional segments include a first selectable functional segment, a second selectable functional segment and a third selectable functional segment, and wherein in use:
a. when the first selectable functional segment is aligned with the input ports and the output ports, the selected function is a first specific switching function causing microwave signals applied to the input ports to be switched toward the output ports in a first manner;
b. when the second selectable functional segment is aligned with the input ports and the output ports, the selected function is a second specific switching function causing microwave signals applied to the input ports to be switched toward the output ports in a second manner distinct from the first manner; and
c. when the third selectable functional segment is aligned with the input ports and the output ports, the selected function is a first specific combining function causing microwave signals applied to the input ports to be combined prior to being released at the output ports so that signals released at the output ports are combined versions of microwave signals applied to the input ports.

14. The transfer device as claimed in claim 11, wherein:
a. the first input port and the second output port lie on a first plane; and
b. the second input port and the first output port lie on a second plane.

15. The transfer device as claimed in claim 14, wherein the first plane and the second plane are distinct from one another.

16. The transfer device as claimed in claim 3, wherein the input ports and the output ports are in the form of apertures configured in the H-plane.

17. The transfer device as claimed in claim 3, wherein the input ports and the output ports are in the form of apertures configured in the E-plane.

18. The transfer device as claimed in claim 3, wherein said at least two selectable functional segments define respective sets of microwave transmission passages, wherein microwave transmission passages in at least one of the respective sets of microwave transmission passages are positioned side-by-side on the translatably displaceable waveguide structure along an axis longitudinal to a direction of displacement of the translatably displaceable waveguide structure.

19. A transfer device for selectively combining and switching microwave signals, said transfer device comprising:
a. a housing;
b. input ports and output ports defined on walls of said housing;
c. a first translatably displaceable waveguide structure positioned within the housing, said first translatably displaceable waveguide structure including at least two selectable functional segments and being selectively translatable along a first axis; and
d. a second translatably displaceable waveguide structure positioned within the housing, said second translatably displaceable waveguide structure including at least two selectable functional segments and being selectively translatable along a second axis;
in use said first and second translatably displaceable waveguide structures being displaced within said housing for selectively combining and switching microwave signals between the input ports and the output ports defined on the walls of the housing;
said first translatably displaceable waveguide structure and said second translatably displaceable waveguide structure being configured so that microwave signals received at the input ports of the transfer device propagate through said first translatably displaceable waveguide structure and through said second translatably displaceable waveguide structure prior to being released at said output ports.

20. The transfer device as claimed in claim 19, wherein said first and second translatably displaceable waveguide structures can be displaced independently from one another within said housing.

21. The transfer device as claimed in claim 20, wherein said housing defines a cavity therein, said first translatably displaceable waveguide structure and said second translatably displaceable waveguide structure being positioned within the cavity defined by said housing.

22. The transfer device as claimed in claim 20, wherein the input ports are located on a first wall of the housing and the output ports are located on a second wall of the housing, said first wall being positioned opposite said second wall.

23. The transfer device as claimed in claim 22, wherein said housing has a generally rectangular shape and wherein the first wall and second walls are opposing walls of the generally rectangular shape.

24. The transfer device as claimed in claim 20, further comprising an actuator for displacing said first translatably displaceable waveguide structure within said housing to selectively align a specific one of said at least two selectable functional segments of the first translatably displaceable waveguide structure with said input ports.

25. The transfer device as claimed in claim 24, wherein the actuator is further configured for displacing said second translatably displaceable waveguide structure within said housing to selectively align a specific one of said at least two selectable functional segments of the second translatably displaceable waveguide structure with said output ports.

26. The transfer device as claimed in claim 19, wherein the input ports include a first input port and a second input port and wherein the output ports include a first output port and a second output port and wherein:
a. the first input port and the second output port lie on a first plane; and
b. the second input port and the first output port lie on a second plane.

27. The transfer device as claimed in claim 26, wherein the first plane and the second plane are essentially co-planar with one another.

28. A method for use in connection with microwave signals comprising:
a. providing a transfer device comprising:
i. a housing defining a cavity therein;
ii. input ports and output ports defined on walls of said housing, wherein the input ports are located on a first wall of the housing, and the output ports are located on a second wall of the housing;
iii. a translatably displaceable waveguide structure positioned within the cavity defined by said housing, said translatably displaceable waveguide structure including at least two selectable functional segments allowing to apply a selected function to microwave signals propagating between the input ports and the output ports;
b. displacing the translatably displaceable waveguide structure of the transfer device within said cavity to align one of said at least two selectable functional segments with the input ports;
c. causing microwave signals to be propagated through a circuit including the transfer device so that microwave signals received at the input ports of the transfer device propagate toward the output ports through the aligned one of said at least two selectable functional segments.

29. A method as defined in claim 28, wherein the function is selected from the set consisting of:
a. at least one switching function; and
b. at least one combining function.

30. A transfer device for selectively combining and switching microwave signals, said transfer device comprising:
a. a housing defining a cavity therein;
b. input ports and output ports defined on walls of said housing; and
c. a translatably displaceable waveguide structure positioned within the cavity defined by said housing, said translatably displaceable waveguide structure including at least two selectable functional segments, in use said translatably displaceable waveguide structure being displaced within said cavity for selectively combining and switching microwave signals between the input ports and the output ports defined on the walls of the housing.
